(19) United States
(12) Patent Application Publication
(10) Pub. No.: US 2010/0247896 A1
(43) Pub. Date: Sep. 30, 2010

(54) FOAM DEVICE FOR USE IN ELECTRONIC APPARATUS

(75) Inventors: DONG-YUN LI, Shenzhen City (CN); WEI ZHANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/494,338

(22) Filed: Jun. 30, 2009

(30) Foreign Application Priority Data
Mar. 24, 2009 (CN) 200910301091.1

(51) Int. Cl. B32B 3/26

(52) U.S. Cl. 428/319.3; 428/318.4; 428/304.4

(57) ABSTRACT

A foam device for use in an electronic device includes a foam and a foam cover for supporting and fixing the foam in position. The foam cover includes a supporting layer and an isolating layer disposed between the supporting layer and a first end of the foam. The isolating layer nonadhesively contacts the foam. The supporting layer adhesively contacts a second end of the foam.

### BACKGROUND

1. Technical Field

The disclosure relates to a foam device, and particularly to a foam device for use in an electronic apparatus as supporting or buffering structure.

2. Description of Related Art

A foam 10 shown in FIG. 1 is widely used as a supporting or a buffering element for an electronic device such as a mobile telephone or an MP3. An adhesive tape or a double sided adhesive tape used as a foam cover 12 is commonly introduced to adhesively contact the foam 10 for supporting and fixing the foam 10 in position. Since the foam 10 is commonly a soft froth material and has a fragile structure, when peeling the foam cover 12 from the foam 10, the foam 10 would be damaged easily by the foam cover 12, especially at ends of the foam 10.

What is needed, therefore, is a foam device which can overcome the limitation described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric, assembled view of a foam and a foam cover in accordance with related art.

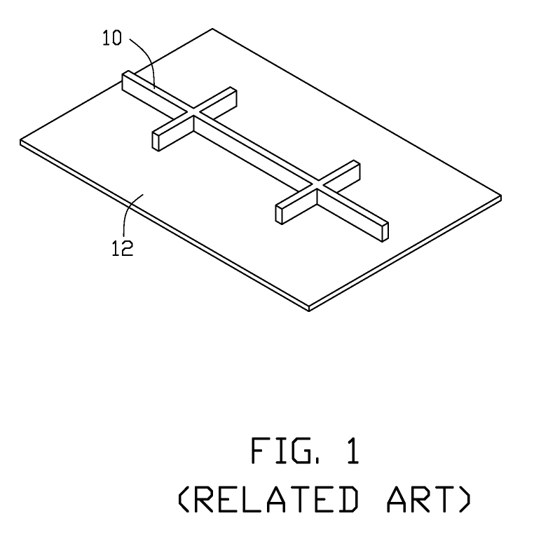

FIG. 2 is an isometric, assembled view of a foam device in accordance with one embodiment of the disclosure.

FIG. 3 is an isometric, exploded view of the foam device of FIG. 2.

### DETAILED DESCRIPTION

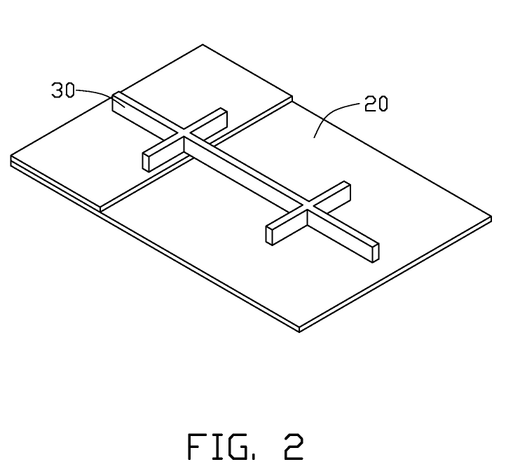

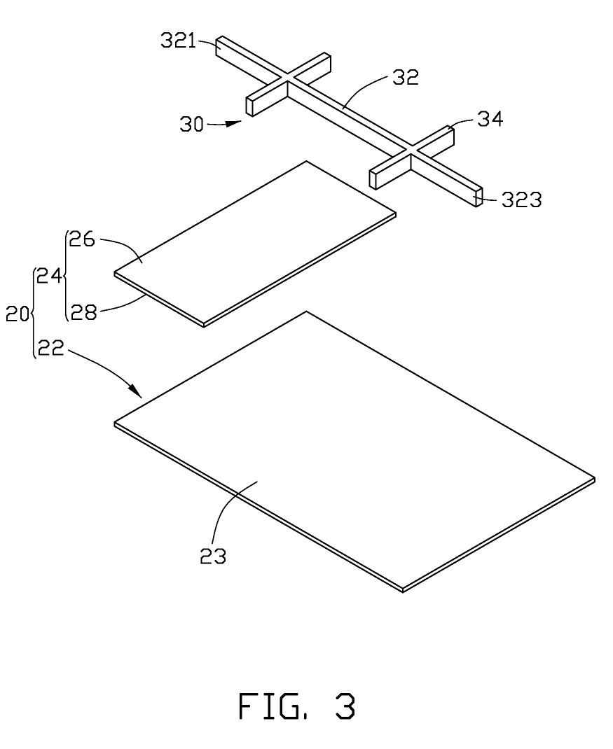

Referring to FIGS. 2-3, a foam device in accordance with an embodiment of the disclosure includes a foam 30 and a foam cover 20 disposed on a bottom of the foam 30. The foam cover 20 is for supporting and fixing the foam 30 in position. The foam 30 which is a soft froth material, is fragile, and would be easily damaged when suffered from an outer force, especially at ends of the foam 30. The foam 30 includes an elongated body 32 and four strips 34 integrally from two sides of the body 32. In this embodiment, the foam 30 is used as a supporting element for a keyboard of a mobile telephone.

The foam cover 20 includes a supporting layer 22 and an isolating layer 24 disposed between the supporting layer 22 and a first end 321 of the foam 30. The isolating layer 24 is a plastic plate or a cardboard with an isolating face 26 at a top thereof and a sticking face 28 at a bottom thereof. A film of silicone oil is spread on the isolating face 26 of the isolating layer 24. The isolating face 26 of the isolating layer 24 nonadhesively contacts the bottom face of the first end 321 of the foam 30. The isolating layer 24 can be peeled from the first end 321 of the foam 30 easily and the foam 30 would not be damaged by the isolating layer 24 during the peeling of the isolating layer 24 from the foam 30. The supporting layer 22 for supporting and fixing the foam 30 in position is an adhesive tape or a double sided adhesive tape with a side thereof stacked/overlapped with a plastic plate. The supporting layer 22 has an adhesive face 23 at a top thereof. The adhesive face 23 of the supporting layer 22 is adhered on/adhesively contacts the bottom face of a second end 323 of the foam 30 and the sticking face 28 of the isolating layer 24. Since the isolating layer 24 is sandwiched between the first end 321 of the foam 30 and the supporting layer 22, the supporting layer 22 adhesively contacts the second end 323 of the foam 30 only. When peeling the foam cover 20 from the first end 321 to the second end 323 of the foam 30, the second end 323 of the foam 30 can be easily separated from the foam cover 20, without being damaged by the foam cover 20.

According to the disclosure, the isolating layer 24 of the foam cover 20 disposed between the first end 321 of the foam 30 and the supporting layer 22 makes the first end 321 of the foam 30 nonadhesively contact the foam cover 20, reducing an adhesively contacting area between the foam cover 20 and the foam 30. When peeling the foam cover 20 from the first end 321 to the second end 323 of the foam 30, the foam 30 can be easily separated from the foam cover 20, without being damaged by the foam cover 20.

It is believed that the disclosure and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A foam device for use in an electronic apparatus, comprising:
a foam; and
a foam cover for supporting and fixing the foam in position, the foam cover comprising a supporting layer and an isolating layer disposed between the supporting layer and a first end of the foam, the isolating layer nonadhesively contacting the foam, the supporting layer adhesively contacting a second end of the foam.

2. The foam device as claimed in claim 1, wherein the isolating layer has an isolating face at a side thereof nonadhesively contacting the foam, the supporting layer having an adhesive face adhesively contacting the foam and the isolating layer.

3. The foam device as claimed in claim 1, wherein a film of silicone oil is spread on a side of the isolating layer towards the foam.

4. The foam device as claimed in claim 1, wherein the foam comprises an elongated body and a plurality of strips integrally from two sides of the body.

5. The foam device as claimed in claim 1, wherein the supporting layer is an adhesive tape.

6. The foam device as claimed in claim 1, wherein the supporting layer is a double sided adhesive tape with a side thereof stacked/overlapped with a plastic plate.

7. The foam device as claimed in claim 1, wherein the isolating layer is a plastic plate.

8. The foam device as claimed in claim 1, wherein the isolating layer is a cardboard.
